(19) United States
(12) Patent Application Publication
(10) Pub. No.: US 2014/0017626 A1
(43) Pub. Date: Jan. 16, 2014

(54) MODEL PLATE ARRAY FOR PRODUCING DENTURES

(71) Applicant: Matthias Funk, Hanau (DE)

(72) Inventor: Matthias Funk, Hanau (DE)

(21) Appl. No.: 14/005,955

(22) PCT Filed: Mar. 5, 2012
(86) PCT No.: PCT/EP2012/000970

§ 371 Date: Sep. 18, 2013

(30) Foreign Application Priority Data
Mar. 18, 2011 (DE) 102011014504.4

(51) Int. Cl. A61C 11/08; A61C 13/08

(52) U.S. Cl. CPC A61C 11/087; A61C 11/088; A61C 13/08
USPC 433/60

(57) ABSTRACT

The invention relates to a two-part model plate array for producing dentures. The model plate array comprises a model plate having a dental crown model and sliding elements, and a model base plate having guides. The sliding elements can be inserted into the guides of the model base plate.

This application is a 371 of International Patent Application No. PCT/EP2012/000970, filed Mar. 5, 2012, which claims priority of German Patent Application No. 10 2011 014 504.4, filed Mar. 18, 2011, the contents of which patent applications are incorporated herein by reference.

The present invention relates to a two-part model plates arrangement for the production of dentures, comprising a dental arch model and a model base plate to allocate the working model (dental arch model+model base plate) in an articulator.

Dentures are traditionally produced on plaster models using a one-piece model base plate, which for this purpose are integrated in an articulator in order to control the contact position of the rows of teeth in reference to each other. Using novel scan technology, such as intraoral or impression scanning, it is increasingly necessary to generate a working model from such digital data. Preferably, constitutive production methods are used here, which allow one to generate dental arch model made from plastic. However, the functions that these plastic models must fulfill are identical to those of conventional plaster models.

Due to the fact that corrections to the working model (plaster or plastic model) cannot be made when it is installed in the articulator in a fixed way, the model base plate must be arranged in the articulator in a detachable fashion. In order to fix the working model with the model base plate in the articulator, it is aligned in the articulator and fixed with plaster. Here, an intermediate plaster body develops between the articulator retention plate and the working model with the mold base plate. In order for the working model with the model base plate to adhere to the predetermined alignment at the intermediate plaster body, the bottom of the model base plate of the working model (installation side pointing towards the top or bottom of the articulator) comprises a rib-like profiling. Due to the fact that, for the production and finishing of the denture, the working model must perhaps be repeatedly removed from the articulator and reinserted, this working model with the model base plate is commonly arranged in the articular in a detachable fashion. For this purpose, as described for example in DE 202 13 830 U1 and DE 10 2004 016 199 B3, the working model with its model base plate is formed in two parts comprising a constituted top showing the primary plate and a secondary plate pointing towards the fastening surface of the articulator.

However, these systems are disadvantageous in that the complementary positioning devices at the primary and secondary plate are pins and recesses that engage in a form-fitting fashion, which is particularly disadvantageous for the constituting production methods. In this method they are material and time intensive (extending the construction period) and additionally they must fit precisely. They therefore allow little production tolerances in order to be detachable from each other on the one hand without accidentally separating on the other hand while the contact position of the rows of teeth is being controlled. Further, in such a fixed connection of the primary and the secondary plate, there is a risk that, during the separation of the primary plate, excessive force will be applied upon the secondary plate, causing it to detach from the articulator or be distorted therein.

The invention is therefore based on the objective of providing a model plates arrangement for dentures, in which, showing greater production tolerances for the fastening devices between the primary and the secondary plate, the fixation of the two plates to each other is ensured, which can be stressed constantly, although they can easily be detached from each other at the same time if necessary.

The objective is attained in the features described hereinbelow.

The model plates arrangement according to the invention for the production of dentures comprises a model element with a dental arch model and gliding elements as well as a model base plate with guide elements matching the glide elements, by which the model plate arrangement can be arranged in an articulator.

The glide elements are preferably planar elements, which can be inserted into the guide elements. Preferably the guide elements laterally encompass the glide plates, such that they can be displaced only in one direction. Here, in the case of two glide elements, it is sufficient for each glide element to be encompassed by one guide element to the point that any movement of the model base plate perpendicular in reference to the guide elements is prevented.

Further, the guide elements and/or the gliding elements preferably comprise positioning elements, which prevent any unintended gliding of the glide element out of the guide bar. Simultaneously, however, the positioning elements are embodied such that the gliding element can be pulled out when moderate force is applied.

Preferably these positioning devices represent recesses or holes in the gliding elements and elevations or projections in the guide element. However, it is also possible that the gliding element shows no positioning device, for example, and the guide element represents a spring element, for example, allowing the gliding element to be held in its position.

The model base plate is provided with devices allowing a mounting at the articulator. They may represent ribs, for example, which extend stellar from approximately the center of gravity of the model base plate towards the outside. Such ribs additionally stabilize the fixation of the dental arch model and its model base plate at the intermediate plaster body. However, this preferably represents an opening for a magnet or a screw.

The model base plate is preferably made from plastic. Plastics commonly also used for the production of dental arch models may be utilized here. The model base plate may also be made from a different plastic, however, which can be deformed thermoplastically, or from other suitable materials, such as aluminum. In the case of plastic, the plate may be produced by way of injection molding, for example.

Advantageously the model plate comprises a recess at the side opposite the dental arch model. The recess preferably shows an area similar to a section of a parable. In particular, when inserting dental arch models covering half or even less of a jaw section it is advantageous for the recess to be embodied polygonally.

The gliding elements can advantageously be simultaneously constituted with the dental arch model, which occurs by methods known per se, such as the rapid prototyping method.

### BRIEF DESCRIPTION OF THE DRAWINGS

In the following the invention is explained in greater detail using the attached drawings as an example.

FIG. 1 shows a two-part model plate arrangement in a perspective illustration.

FIG. 2 shows a second perspective illustration of a two-part model plate arrangement according to the invention, with both parts being shown separately.

FIG. 3 shows a top view of a two-part model plate arrangement according to the invention.

FIG. 4 shows a cross-section of a two-part model plate arrangement along the line B-B in FIG. 3.

FIG. 5 is a two-fold enlarged detail C of FIG. 4 and shows the engagement of the recesses and projections of the embodied positioning devices of a two-part model plate arrangement according to the invention.

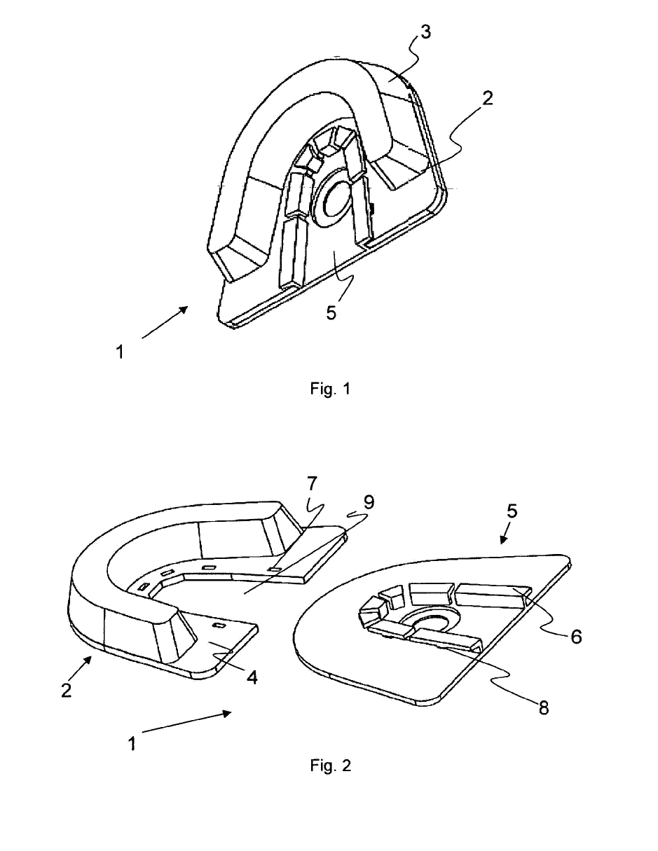

FIG. 1 shows a model plate arrangement 1 according to the invention. The illustration shows the two-part design comprising the model plate 2 and the model base plate 5. The dental arch model 3 is shown only schematically. It forms a part of the model plate 2.

FIG. 2 shows both parts of the model plate arrangement 1 separated from each other. The gliding elements 4 point inwardly from the dental arch model 3. They surround a parabolic recess 9. This way, the edges of the recess 9 are arranged obliquely in reference to each other, so that the recess is wider at the exterior edge. This allows the gliding elements 4 to be inserted easier into the guides 6 of the model base plate 5. The gliding elements 4 show recesses 7 along their inner edges, with projections 8 engaging them at the guides 6 when the model plate 2 and the model base plate 5 are pushed completely over top of each other.

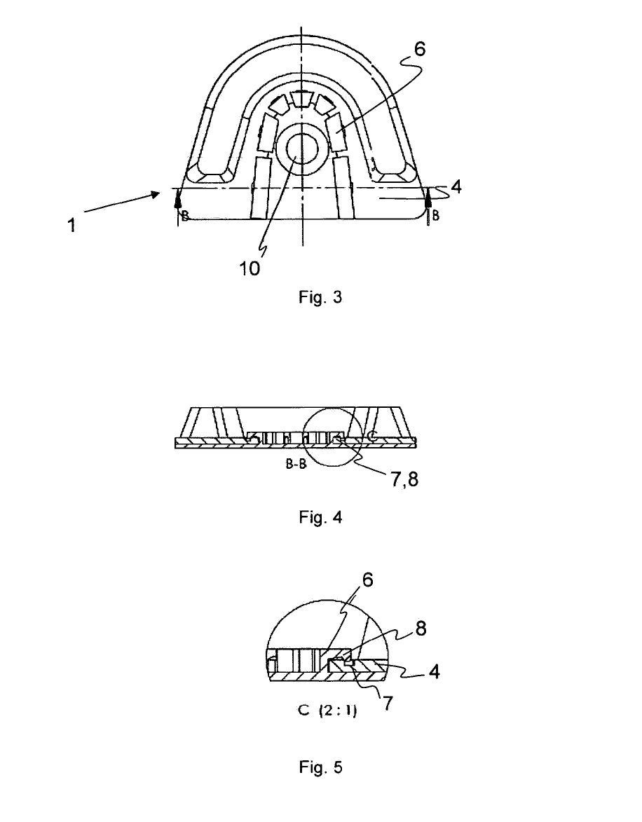

FIG. 3 shows the model plate arrangement 1 from the top once more in an assembled state. Here, too, it is clearly discernible that the edges of the gliding elements 4 as well as the guides 6 slightly open towards the edge. In order to fasten the model plate arrangement, an opening 10 is provided in the model base plate, which is surrounded by a lowered section in the modelbase plate. A magnet or a screw can be inserted in said lowered section in order to fix the model plate arrangement in an articulator.

FIG. 4 shows a section along the line B-B of FIG. 3. The section C, which is shown once more enlarged in FIG. 5, illustrates the positioning elements 7, 8. They represent projections 8 at the guides 6, engaging recesses 7 in the gliding elements 4.

The invention is not limited to the above-stated exemplary embodiments. Rather, a plurality of variants is possible, which also generally implement differently designed embodiments of features of the invention.

### LIST OF REFERENCE CHARACTERS

1 Model plates arrangement

2 Model plate

3 Dental arch model

4 Gliding elements

5 Model base plate

6 Guide elements

7, 8 Positioning devices

9 Recess

10 Opening

1. A model plates arrangement for the production of dentures, comprising a model plate and a model base plate for arranging the model plates arrangement in an articulator, wherein the model plate comprises a dental arch model and gliding elements, and the model base plate comprises guides matching the gliding elements.

2. A model plates arrangement according to claim 1, wherein the model base plate comprises positioning devices, which can engage positioning devices of the model plate in a detachable fashion.

3. A model plate arrangement according to claim 1, wherein the model plate is formed in one piece.

4. A model plates arrangement according to claim 1, wherein the model plate comprises a recess at the side opposite the dental arch model, which is laterally limited by the gliding elements.

5. A model plates arrangement according to claim 1, wherein the model plate comprises a recess at the side opposite the dental arch model, which is parabolic.

6. A model plates arrangement according to claim 4, wherein the recess is embodied polygonally.

7. A model plates arrangement according to claim 1, wherein the guides encompass the gliding elements.

8. A model plates arrangement according to claim 1, wherein the model plate and the dental arch model cover a full, half, or also smaller jaw section.

9. A model plates arrangement according to claim 1, wherein the gliding elements and the guides comprise engaging positioning devices.

10. A model plates arrangement according to claim 9, wherein the gliding elements comprise recesses or indentations and the guides comprise elevations.

11. A model plates arrangement according to claim 1, wherein the model base plate comprises an opening inside a lowered section to accept a magnet or a screw.

12. A model plates arrangement according to claim 5, wherein the recess is embodied polygonally.
